(19) United States
(12) Patent Application Publication
(10) Pub. No.: US 2024/0078304 A1
(43) Pub. Date: Mar. 7, 2024

(54) MOBILE USER AUTHENTICATION SYSTEM AND METHOD

(71) Applicant: Visa International Service Association, San Francisco, CA (US)

(72) Inventors: Yuexi Chen, Foster City, CA (US); Sirajuddin Nazir, Dublin, CA (US)

(73) Assignee: Visa International Service Association, San Francisco, CA (US)

(21) Appl. No.: 18/261,569

(22) PCT Filed: Jan. 14, 2022
(86) PCT No.: PCT/US2022/012548

§ 371 Date: Jul. 14, 2023

Related U.S. Application Data
(60) Provisional application No. 63/139,230, filed on Jan. 19, 2021.

(51) Int. Cl. G06F 21/35; G06Q 20/32; G06Q 20/40; H04W 12/069; H04W 12/47

(52) U.S. Cl. CPC G06F 21/35; G06Q 20/3223; G06Q 20/4014; H04W 12/069; H04W 12/47

(57) ABSTRACT

Methods and systems for mobile cardholder authentication are provided. An access device can obtain interaction data produced during an interaction between a user and the resource provider computer in which the user attempts to obtain a resource from a resource provider and user device data comprising a cryptogram and supplemental data from the user device or another user device operated by the user. The cryptogram of the user device can be validated and the interaction data and user device data can be compared to determine that the user interacting with the access device is the same user as the user that interacted with the resource provider computer. The access device can provide an indication that the resource will be provided to the user responsive to determining that the user interacting with the access device is the same user as the user that interacted with the resource provider computer.

### CROSS REFERENCE TO RELATED APPLICATIONS

This application claims priority to U.S. Provisional Patent No. 63/139,230, filed on Jan. 19, 2021, the entirety of which is incorporated by reference herein.

### BACKGROUND

In many instances, one may obtain goods or services by ordering the goods or services from a platform associated with a resource provider (e.g., a merchant) prior to receipt of the goods/services. As an illustrative example, a user can order goods online through a webpage maintained by a resource provider and then pick up the goods at a retail location of the resource provider, which may be referred to as “curbside pickup.” As another example, a user may reserve a ticket to travel on a vehicle (e.g., an airplane) prior to the departure of the vehicle and subsequently purchase a ticket and board the vehicle.

However, such a multi-step process to order and receive the goods/services can include fraudulent receipt of the goods/services. For instance, when goods are to be picked up at a retail location of a resource provider, goods ordered by a user can be fraudulently obtained by another individual. As another example, an individual that fraudulently gained access to payment card data of a user can order goods/services from a resource provider and fraudulently obtain the goods/services.

To mitigate fraudulent receipt of goods/services, many resource providers may attempt to further verify the identity of the user obtaining the goods/services. For example, a representative of the resource provider can manually compare a government-issued identification card with information provided at the portal maintained by a resource provider to verify the identity of the user.

Such a verification process can be inefficient and tedious. Further, such a verification process requiring the production of a government-issued identification card or other user-identifying information can result in dissemination of sensitive user information.

Embodiments of the present application address these and other problems individually and collectively.

### SUMMARY

One embodiment of the invention includes to a method. The method comprises: receiving, by an access device, interaction data from a resource provider computer operated by a resource provider, the interaction data produced during an interaction between a user and the resource provider computer in which the user attempts to obtain a resource from the resource provider using a user device; receiving, by the access device, user device data comprising a cryptogram and supplemental data from the user device or another user device operated by the user; obtaining, by the access device, validation of the cryptogram; after obtaining the validation of the cryptogram, comparing, by the access device, the interaction data and the supplemental data; determining, by the access device, the user interacting with the access device is the same user as the user that interacted with the resource provider computer; and providing, by the access device, an indication that the user is the resource will be provided to the user.

Another embodiment of the invention includes an access device comprising: a processor; and a non-transitory computer readable medium having instructions stored thereon that, when executed by the processor, cause the access device to: receive interaction data from a resource provider computer operated by a resource provider, the interaction data produced during an interaction between a user and the resource provider computer using a user device; receive user device data comprising a cryptogram and supplemental data from the user device or another user device operated by the user; obtain validation of the cryptogram; after obtaining validation of the cryptogram, compare the interaction data and the supplemental data to derive a similarity between the interaction data and the supplemental data included in the user device data; determine the user interacting with the access device is the same user as the user that interacted with the resource provider computer responsive to identifying the similarity between the interaction data and the supplemental data included in the user device data exceeding a threshold; and provide an indication that a resource will be provided to the user.

Another embodiment of the invention includes a method comprising: providing, by a communication device, to a resource provider computer, interaction data; and providing, by a user device to an access device at a location of the resource provider, user device data comprising a cryptogram and supplemental data, wherein the access device receives the interaction data from the resource provider computer, obtains validation of the cryptogram, and compares interaction data and the supplemental data, determines that the user interacting with the access device is the same user as the user that interacted with the resource provider computer, and provides an indication that a resource will be provided to the user.

Further details regarding embodiments of the invention can be found in the Detailed Description and the Figures.

### BRIEF DESCRIPTION OF THE DRAWINGS

FIG. 1 shows a block diagram of a system according to an embodiment of the invention.

FIG. 2 shows a block diagram of an exemplary user device according to an embodiment of the invention.

FIG. 3 shows a block diagram of an exemplary access device according to an embodiment of the invention.

FIG. 4 shows a flow diagram illustrating a method according to embodiments of the invention.

FIG. 5 shows a flow diagram illustrating transaction processing communications between a user device and access device.

### DETAILED DESCRIPTION

Embodiments of the include systems and methods for authenticating a user providing user device data provided by a user device (e.g., a payment or access card). For instance, users can interact with a remotely located resource provider computer (e.g., a Website) operated by the resource provider to order goods/services and later obtain the goods/services or access to a secure location from the resource provider. To mitigate fraudulent receipt of goods/services or entry into a secure location, the system as described herein can authenticate an identity of the user based on user device (e.g., payment card) data provided to an access device. Particularly, the access device can authenticate the user by determining that the user associated with the interaction data is the same user that is associated with the user device.

As an illustrative example, a user device can be dipped or tapped to a reader of an access device to provide user device data (e.g., a cryptogram, details such as payment details or access details) specific to the user device. In this example, the access device can verify the cryptogram as valid and compare user details (e.g., name, billing address) included in the interaction data and user details associated with the user device to determine whether the user associated with the interaction data is the same user that is associated with the user device.

Some embodiments can include the access device performing a dummy transaction (e.g., which causes the generation of an authorization request using the user device details but including at least one null field) using the user device details. Responsive to determining that the user device is valid, the access device can verify that the user associated with the interaction data is the same user associated with the user device.

Accordingly, rather than manually inspecting an identifying card provided by a user to manually identify the user, the access device as described herein can securely verify the identity of the user without disseminating sensitive user information. The access device, responsive to authenticating the user, can provide an indication that the resource (e.g., the goods/services) are to be provided to the user.

Such methods are also useful when a user seeks to obtain rapid and “contactless” curbside delivery of goods at a resource provider such as a merchant. This is helpful to mitigate the spread of pathogens between individuals. In embodiments of the invention, the user may have already purchased an item at a merchant on a Website, but then goes to the merchant to pick up the purchased item. The user only needs to wave or insert his payment card into a reader that is at the resource provider to confirm that the user is the same user that purchased the item online. Once the user is confirmed, then an employee of the resource provider can give the item to the user with minimal interaction with the user. This same sort of contactless interaction can take place with non-payment type activities such as when a user attempts to access a secure location with an access badge.

Responsive to authenticating the user, the access device can provide an indication that the resource will be provided to the user. This can include an output message/display on the access device indicating to provide resources (e.g., goods/services) to the user. The indication can identify details relating to the goods/services (e.g., item numbers, order number) identifying the goods/services to be provided to the user.

In some embodiments, determining that the user interacting with the access device is the same user as the user that interacted with the resource provider computer can be based on a score derived by the access device. The score can be indicative of a similarity between the interaction data and the user device data. For example, the score can be based on a number of similar features (e.g., name, address, phone number, age) between the interaction data and the user device data. Accordingly, the score can provide a confidence that the user interacting with the access device is the same user as the user that interacted with the resource provider computer.

The access device can determine whether the derived score exceeds a threshold value indicative of a threshold confidence that the user interacting with the access device is the same user as the user that interacted with the resource provider computer.

Prior to discussing specific embodiments of the invention, some terms may be described in detail.

A “user device” may include any suitable device associated with a user. The user device may comprise a substrate such as a plastic card, and information that is printed, embossed, encoded, or otherwise included at or near a surface of an object. The user device may include circuitry with, for example, permanent voltage values for storing information. Suitable user devices can be hand-held and compact so that they can fit into a user's wallet and/or pocket (e.g., pocket-sized). A user device can operate at least in a contact mode. As an example, a user device can include a smart card. In some embodiments, a smart card can serve as a payment card, a security card, an access card, or any other suitable type of card. If the user device is in the form of a debit, credit, or smartcard, the user device may also optionally have features such as magnetic stripes. In some embodiments, a user device may be used to conduct a financial transaction. Such a user device may be referred to as a “payment device.” For example, a user device may be associated with a value such as a monetary value, a discount, or store credit, and a user device may be associated with an entity such as a bank, a merchant, a payment processing network, or a person. The user device can include “user device data” which includes authentication or authorization data such as a cryptogram or payment card details such as a primary account number or token. “User device data” may also include information identifying a user, which may be generically referred to as “supplemental data.” The supplemental data can be maintained by an authorizing entity and received by the access device responsive to a request by the access device for the supplemental data.

A “credential” may include any suitable information that serves as reliable evidence of worth, ownership, identity, or authority. A credential may be a string of numbers, letters, or any other suitable characters that may be present or contained in any object or document that can serve as confirmation. Examples of credentials include payment credentials, cryptograms, access credentials, and any other suitable type of credentials.

“Payment credentials” may include any suitable information associated with an account (e.g., a payment account and/or payment device associated with the account). Such information may be directly related to the account or may be derived from information related to the account. Examples of payment credentials may include a PAN (primary account number or “account number”), user name, expiration date, and verification values such as CVV (card verification value), dCVV (dynamic card verification value), CVV2 (card verification value 2), CVC3 card verification values, etc. An example of a PAN is a 16-digit number, such as “4147 0900 0000 1234.” In some embodiments, payment credentials can include additional information that may be used for authorizing a transaction. For example, payment credentials can include a cryptogram associated with the transaction.

An “encryption key” may include any data value or other information suitable to cryptographically encrypt data. A “decryption key” may include any data value or other information suitable to decrypt encrypted data. In some cases, an encryption key and a decryption key may be the same (i.e., a “symmetric key”).

A “cryptogram” may include encrypted information. For example, a cryptogram can be a set of text encrypted with an encryption key.

An “access device” may be any suitable device that provides access to a remote system. An access device may also be used for communicating with a merchant computer, a transaction processing computer, an authentication computer, or any other suitable system. An access device may generally be located in any suitable location, such as at the location of a merchant. An access device may be in any suitable form. Some examples of access devices include POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. An access device may use any suitable contact or contactless mode of operation to send or receive data from, or associated with, a user device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a user device. In some embodiments, a cellular phone, tablet, or other dedicated wireless device used as a POS terminal may be referred to as a mobile point of sale or an “mPOS” terminal.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization. As noted above, in some embodiments, a transaction processing computer may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

A “resource provider computer” can include a computer, server, or series of interconnected computers maintained by or associated with a resource provider. A resource provider can include an entity (e.g., a merchant, retailer) providing resources (e.g., goods/services) to a user. The resource provider computer can provide a webpage/portal allowing for users to request/order goods or services. The information provided by the user requesting the goods/services can be referred to as “interaction data.” The interaction data can include information relating to the requested goods/services (e.g., item numbers, a total value for the goods/services), user details (e.g., user name, age, address), user device details, etc.

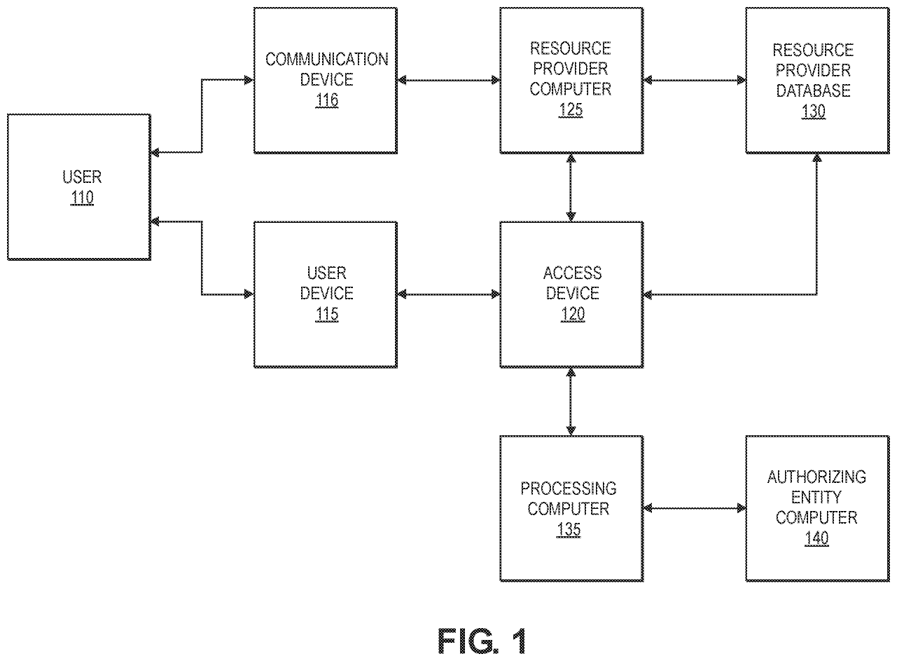

FIG. 1 shows a system 100 comprising a number of components. The system 100 comprises a user device 115 and a communication device 116 operated by a user 110. The system 100 further comprises an access device 120, a resource provider computer 125, a resource provider database 130, a processing computer 135, and an authorizing entity computer 140, each of which may be embodied by one or more computers.

The user device 115 may be capable of interacting with the access device 120, which may in turn be in communication with the resource provider computer 125, resource provider database 130, and/or the processing computer 135. Also, the access device 120, resource provider computer 125, processing computer 135, and the authorizing entity computer 140 may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

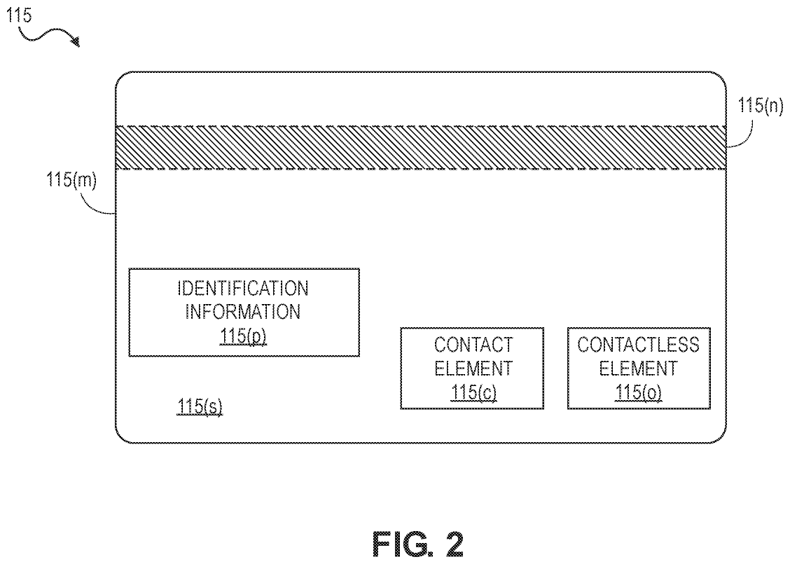

An example of the user device 115, according to some embodiments of the invention, is shown in FIG. 2. As shown, in some embodiments, the user device 115 can take the form of a card comprising a plastic substrate 115(s). In some embodiments, the user device 115 may comprise a contact element 115(c) that is present on, or embedded within, the plastic substrate 115(s). A contact element 115(c) may include a microprocessor and/or a memory (e.g., memory chips with user data stored in them). The contact element 115(c) may enable the user device 115 to interface and communicate with the access device 120. In some embodiments, a contactless element 115(o) for interfacing with an access device may also be present on, or embedded within, the plastic substrate 115(s). A magnetic stripe 115(n) may also be on the plastic substrate 115(s). Identification information 115(p) may be printed or embossed on the card. Identification information can include, for example, an account number, expiration date, and/or a user name.

The user 110 may be able to use the user device 115 to conduct transactions with a resource provider associated with the resource provider computer 125. The user device 115 may store information associated with the user 110 and/or an account (e.g., at the contact element 115(c)). For example, the user device 115 may be a smart payment card, and the contact element 115(c) may store payment credentials as well as personal information such as a name, address, email address, phone number, or any other suitable identification information 115(p). The contact element 115(c) may be able to provide this information to the access device 120 during a transaction. The user device 115 may be assigned to a user 110 by an authorizing entity, such as an issuer bank.

The user 110 may also operate a communication device 116, such as a portable computer (e.g., a laptop computer, mobile phone, etc.). The communication device 116 can communicate with the resource provider computer 125, which may be remotely located with respect to the communication device 116. In some embodiments, the communication device 116 and the user device 115 may be the same device, such as when they are both the same mobile phone.

Referring back to FIG. 1, the resource provider computer 125 may be associated with a resource provider, which may be an entity that can provide a resource such as goods, services, information, and/or access. Examples of a resource provider include merchants, access devices, secure data access points, etc. A merchant may typically be an entity that engages in transactions and can sell goods or services, or provide access to goods or services. Resource provider data (e.g., interaction data) can be maintained by a resource provider database 130.

The resource provider may accept multiple forms of payment (e.g., the user device 115) and may use multiple tools to conduct different types of transactions. For example, the resource provider may operate a physical store and use the access device 120 for in-person transactions. The resource provider may also sell goods and/or services via a Website on the resource provider computer 125, and may accept payments over the Internet.

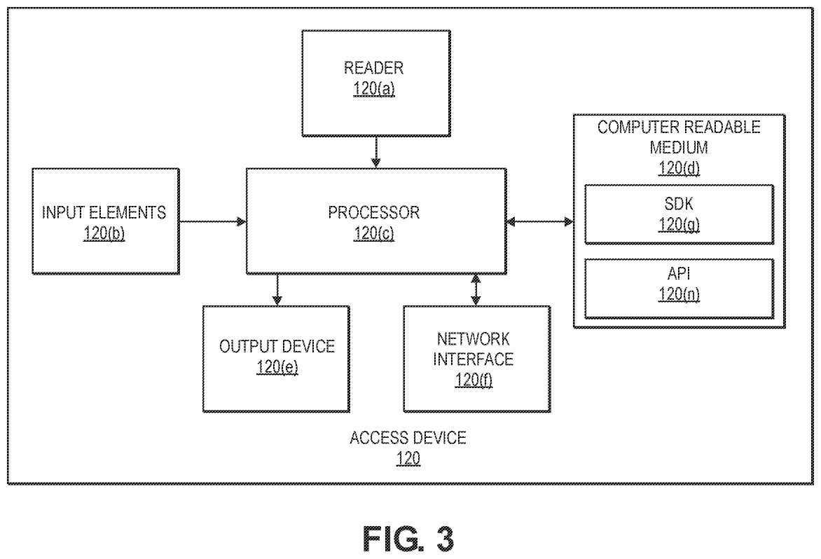

An example of the access device 120, according to some embodiments of the invention, is shown in FIG. 3. The access device 120 may comprise a processor 120(c) operatively coupled to a computer readable medium 120(d) (e.g., one or more memory chips, etc.), input elements 120(b) such as buttons or the like, one or more readers 120(a) (e.g., a contact chip reader, a contactless reader, a magnetic stripe reader, etc.), an output device 120(e) (e.g., a display, a speaker, etc.) and a network interface 120(f). A housing may house one or more of these components.

The computer readable medium 120(d) may comprise instructions or code, executable by a processor. The instructions may include instructions for sending a command to a user device 115 upon making contact with that device, and instructions for communicating with the user device 115 to obtain credentials and otherwise process a transaction. The computer readable medium 120(d) may also include instructions for requesting authorizing of a transaction with the authorizing entity computer 140, and instructions for any other suitable function as described herein.

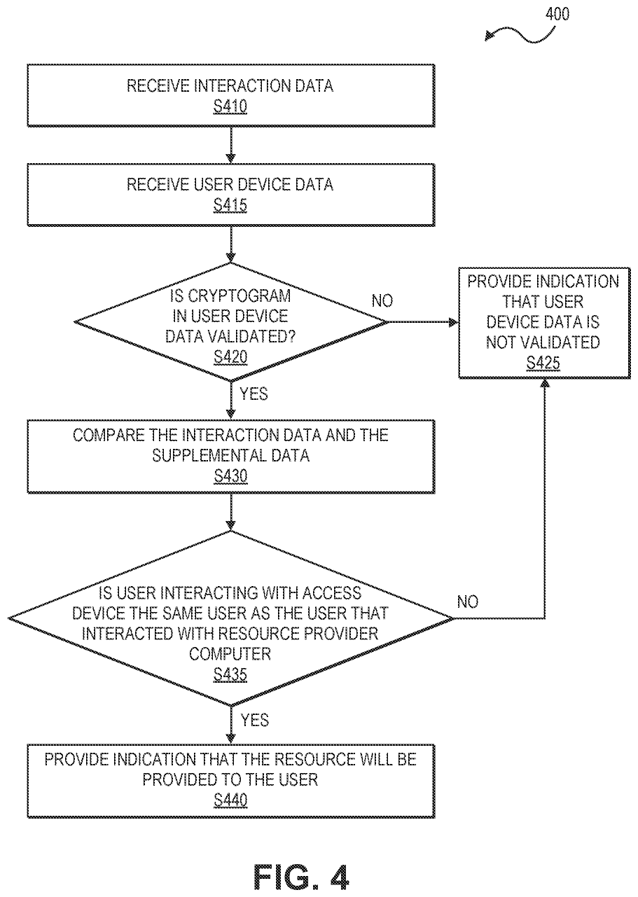

The computer readable medium 120(d) can include a series of instructions that, when executed, cause the processor 120(c) to perform a method of authenticating a user as described herein. The computer readable medium 120(d) of the access device 120 can include an SDK 120(g), which performs at least the comparing step (e.g., step S430 as described in FIG. 4). The instructions in the computer readable medium 120(d) can be included in the software development kit (SDK) 120(g). The one or more tools/application included in the SDK 120(g) can securely access data provided by any of the resource provider computer 125, resource provider database 130, and/or processing computer 135 to obtain interaction data, verify a user device, authenticate a user, etc., as described herein. The information included in the SDK 120(g) can be isolated from other applications of the access device so as to securely connect to and transmit data between resource provider computer 125, resource provider database 130, and/or processing computer 135.

The computer readable medium 120(d) can also include an application programming interface (API) 120(h) allowing for secure connection and communication with resource provider computer 125 and/or resource provider database 130. The API 120(h) can define the interaction between the access device 120 and the resource provider. The API 120(h) can enhance security of data communicated between access device 120 and the resource provider computer 125 and/or resource provider database 130.

The computer readable medium 120(d) can also include instructions stored thereon that, when executed by the processor 120(c), cause the access device 120 to: receive interaction data from a resource provider computer operated by a resource provider, the interaction data produced during an interaction between a user and the resource provider computer; receive user device data comprising a cryptogram and supplemental data from the user device or another user device operated by the user; obtain validation of the cryptogram; after obtaining validation of the cryptogram, compare the interaction data and the supplemental data to derive a similarity between the interaction data and the supplemental data included in the user device data; determine the user interacting with the access device is the same user as the user that interacted with the resource provider computer responsive to identifying the similarity between the interaction data and the supplemental data included in the user device data exceeding a threshold; and provide an indication that a resource will be provided to the user

Referring back to FIG. 1, the processing computer 135 may be disposed between (e.g., in an operational sense) the access device 120 and the authorizing entity computer 140. The processing computer 135 may include data processing subsystems, networks, and operations used to support and deliver authorization services, exception file services, and clearing and settlement services. For example, the processing computer 135 may comprise a server coupled to a network interface (e.g., by an external communication interface), and databases of information. The processing computer 135 may be representative of a transaction processing network. An exemplary transaction processing network may include VisaNet™. Transaction processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The processing computer 135 may use any suitable wired or wireless network, including the Internet.

The authorizing entity computer 140 may be associated with an authorizing entity, which may be an entity that authorizes a request. An example of an authorizing entity may be an issuer, which may typically refer to a business entity (e.g., a bank) that maintains an account for a user. An issuer may also issue and manage a payment account associated with the user device 115.

The processing computer 135 and the authorizing entity computer 140 may operate suitable routing tables to route authorization request messages and/or authorization response messages using payment credentials, merchant identifiers, or other account identifiers.

A method 400 according to embodiments of the present application can be described with respect to FIG. 4.

The method 400 provides secure authentication of a user by determining whether a user interacting with an access device 120 is the same user as the user that interacted with the resource provider computer 125. In a specific example, the method 400 can include determining that a user that purchased an item online on a resource provider website for pickup at a retail location of the resource provider is the same person that is picking up the item that was purchased.

At step S410, the access device 120 can receive interaction data from a resource provider computer 125 operated by a resource provider. The interaction data can be produced during an interaction between a user and the resource provider computer 125 in which the user attempts to obtain a resource from the resource provider (e.g., as in an e-commerce transaction). The interaction data can be obtained by any of a resource provider computer 125 and resource provider database 130. As an example, interaction data can include details associated with a transaction conducted between a communication device 116 operated by a user and a resource provider's Website on the resource provider computer 125. For example, the interaction data provided by the user to the resource provider computer 125 may include a name, address, etc. of the user. In this example, the user does not immediately receive the requested resource (e.g., a purchased good) since the purchase is made online, but plans to go to a location of the resource provider to pick up the purchased resource. In another example, a person can interact with the resource provider computer 125 to obtain access to a secure location provided by the resource provider. The user would go to the location of the resource provider to access the secure location.

In the purchase example, after the user arrives at the resource provider location to obtain his or her purchased resource, an employee of the resource provider operating the access device 120 at the resource provider location can meet the user (e.g., when the user is in their car). The access device 120 can be in the form of a contactless terminal such as a mobile contactless payment terminal.

At step S415, the access device 120 can receive user device data comprising a cryptogram and supplemental data from the user device or another user device 115 operated by the user in an interaction between the user device 115 and the access device 120. For instance, this can include the user device 115 (e.g., a payment card) being dipped or tapped to a reader 120(a) of the access device 120. In some embodiments, the user device data can be provided wirelessly to the access device 120 from a user device in the form of a mobile device associated with the user. In these embodiments, the mobile device (e.g., via an application executing on the mobile device) can utilize a short-range wireless communication protocol (e.g., Near-Field Communication (NFC)) to provide user device data to the access device 120. In some instances, the mobile device can provide user device data via a digital wallet application executing on the mobile device.

In some embodiments, the user device 115 that is interacting with the access device 120 can be the same user device that is associated with the interaction data. For example, the user device may be a credit card that was used to buy an item online at a resource provider Website. The user may use the same credit card to identify himself at the access device when picking up the item.

In other embodiments, receiving the user device data can include receiving user device data comprising a cryptogram and supplemental data from another user device operated by the user. For example, this can include a first user device (e.g., a physical payment card with the user's name) being associated with the interaction data and a second user device (e.g., a mobile phone with a virtual payment card corresponding to the physical payment card being loaded on the mobile phone) being associated with the user device data. The user device 115 provided to the access device 120 can be different than the user device associated with the interaction data (e.g., a first payment card issued by a first bank is used to order goods in the interaction data and a second payment card issued by a second bank, different from the first bank, that is used at a retail location to authenticate the user). In these embodiments, the access device 120 can compare user-identifying details in both the interaction data and the user device data to identify that the user associated with the interaction data is the same user that is associated with the user device.

At step S420, the access device 120 can determine whether the cryptogram in the user device 115 is validated. This can include obtaining validation of the cryptogram. For example, this can include the access device 120 or another computing device (e.g., processing computer 135, authorizing entity computer 140) determining whether the cryptogram (and other payment details included in the user device) is valid.

In some embodiments, the access device 120 can validate the cryptogram received from the user device 115. For instance, the access device 120 (e.g., SDK 120(g)) can verify an asymmetric signature cryptogram using a suitable verification technique (e.g., Dynamic Data Authentication (DDA), combined DDA, fast DDA (fDDA), offline data authentication (ODA)) as defined in various standards (e.g., EMVCo standards). In some embodiments, the access device 120 may store or retrieve a cryptographic key that that corresponds to the cryptographic key in the user device 115 that was used to encrypt data such as an account number, and other data (e.g., secrets, random numbers, etc.) on the user device 115 to form the cryptogram. The access device 120 can receive the cryptogram and the account number, and the supplemental data, and could decrypt the cryptogram to recover the account number and compare the decrypted account number to the received account number to validate the cryptogram.

In other embodiments, the access device 120 can send the cryptogram (and associated payment device details) to a remote computing device (e.g., processing computer 135, authorizing entity computer 140) via an SDK for verification. In some embodiments, the access device 120 can send a received symmetric signature cryptogram (e.g. Cryptogram Version Number 10 (CVN10), Cryptogram Version Number 17 (CVN17), Cryptogram Version Number 18 (CVN18), Cryptogram Version Number 22 (CVN22)) to a processing computer 135 that can route the cryptogram to the authorizing entity computer 140. The authorizing entity computer 140 can have a symmetric master key (in a hardware security module (HSM)) that can be used to verify the cryptogram. In some embodiments, the cryptogram can be decrypted with the symmetric master key to obtain data from the cryptogram, and that data can be compared to other data obtained by the authorizing entity computer 140 to validate the cryptogram.

The authorizing entity computer 140 can validate the validity of the cryptogram and other payment device details and generate a verification result indicating whether the cryptogram (and associated payment device details) is valid. This can include cryptographically verifying the cryptogram with the symmetric master key and/or comparing provided payment device details with recorded details at the authorizing entity computer 140. The verification result can also indicate whether the payment device is valid, whether the payment device is expired, whether payment device details (e.g., cardholder name, primary account number (PAN)) match the details on record at the authorizing entity computer 140, etc. The verification result can be used by the access device 120 to determine whether the user device data received at the access device 120 is valid.

In some embodiments, obtaining validation of the cryptogram comprises the access device 120 generating an authorization request message comprising the user device data comprising the cryptogram and the supplemental data. The authorization request message can include the user device data and at least one null field (e.g., a zero dollar amount in the amount field) to indicate that the transaction being performed is a dummy transaction using the user device data. The access device 120 can transmit the authorization request message to a processing network computer or an authorizing entity computer. The access device 120 can also receive an authorization response message comprising an authorization result from the processing network computer or the authorizing entity computer. The authorization result may indicate that the cryptogram and the user device were successfully validated.

At step S425, responsive to a determination that the cryptogram in the user device data is not validated, the access device 120 may provide an indication that the user device data is not validated.

The indication that the user device data is not validated can be provided via a message displayed on the access device or another resource provider device (e.g., a mobile device or reader associated with a resource provider operator) indicating that the user device provided is not validated. This indication can alert the resource provider to prevent providing goods/services to the user without further authentication. In some instances, the access device 120 can read another user device and verify details of a new user device to authenticate the user. In another instance, the resource provider can match interaction data with information provided in an identification card provided by the user.

The indication that the user device provided is not validated can be based on user device details not being validated. For instance, the indication can be provided based on a cryptogram not being validated, the user device being identified as expired or reported stolen, user device details not matching stored details at the authorizing entity computer 140, etc.

At step S430, after obtaining the validation of the cryptogram, the access device 120 can compare the interaction data and the supplemental data associated with the user device. This can include the access device 120 identifying a number of similarities between the interaction data and supplemental data, indicative that the user associated with the interaction.

As an illustrative example, the access device 120 can arrange interaction data (e.g., information provided by a user during an interaction with resource provider computer 125) and supplemental data (e.g., data provided by authorizing entity computer 140 that corresponds with the user device) by data type (e.g., name, age, billing address). The access device 120 can identify a number of similarities between the interaction data and supplemental data by data type. The identified similarities can be used to determine whether the user interacting with the access device 120 is the same user as the user that interacted with the resource provider computer 125 with respect to step S435.

At step S435, the access device 120 can determine whether the user interacting with the access device 120 is the same user as the user that interacted with the resource provider computer 125. This can include verifying that the user that provided the interaction data to the resource provider computer 125 (e.g., to order goods/services provided by a resource provider on a merchant portal executing on the resource provider computer 125) is the same user associated with a user device provided to the access device 120.

As an example, the access device 120 can determine that user device details in the interaction data provided to the resource provider computer 125 correspond to the same user device that was provided to the access device 120. In such an instance, the access device 120 can identify matching user device details (e.g., PAN, expiration date, Card Verification Value (CVV)) and/or matching supplemental data (e.g., user name, age, address). The access device 120 can determine that the number of matching details between the interaction data and the supplemental data verify that the user providing the interaction details matches the user associated with the user device provided to the access device 120.

In some embodiments, determining that user device details in the interaction data provided to the resource provider computer 125 correspond to the same user device that was provided to the access device 120 includes determining whether a number of similarities between interaction data and supplemental data exceed a threshold.

As an example, a user device (e.g., payment card) provided in the interaction data can differ from the user device provided to the access device 120. In this example, despite differing user device details (e.g., PAN, expiration date, CVV), the access device 120 can identify a number of similar user identifying characteristics (e.g., user name, address, age) common between the interaction data and the supplemental data that exceed a threshold. Accordingly, the access device 120 can verify an identity of a user by identifying a number of common characteristics between the interaction data and the supplemental data and determining whether the number of common characteristics exceed a threshold. For example, a first payment card held by a user may have the name “Joseph P Kilpatrick” on it and may have been used to purchase an item online in an e-commerce transaction. The user may go to the resource provider to pick up the item and may tap a different card such as an identification card or another payment card having the name “Joseph Kilpatrick” on it to the access device 120 operated by an employee of the resource provider. The access device 120 may compare the two names and may give this a high score indicating that the person who purchased the item online is the same person picking up the item, because “Joseph Kilpatrick” is substantially similar to “Joseph P. Kilpatrick.”

In some instances, a number of similarities between the interaction data and the supplemental data can be represented in a score that can be used to verify the identity of the user. For example, following with the above example, the first payment card and the second payment card may have substantially similar names (e.g., Joseph Kilpatrick vs. Joseph P. Kilpatrick), different account numbers, but the same zip code. The match score for these two payment cards might be 67 percent since two out of three data elements match or substantially match. If the user had used the same payment card to both buy the particular item online and to pick up the item at the resource provider's location, then the match score would be 100 percent, since the information would exactly match. For instance, in some embodiments, the access device or an SDK on the access device can return the following verification result to the resource provider:

match_percentage”:100;
“cardholderNameMatch”:true;
“cardPanMatch”:true;
“legitCard”:true;
“expiredCard”:false;

As noted above, the access device or the resource provider may set a threshold (e.g., greater than 60 percent match) before allowing the user to obtain the item at the resource provider.

Responsive to determining that user device details in the interaction data provided to the resource provider computer 125 do not correspond to the same user device that was provided to the access device 120, the access device 120 can provide an indication that the user device is not validated, as discussed in step S425.

At step S440, the access device 120 or the person operating the access device 120 can provide an indication that the resource will be provided to the user. This can be performed responsive to determining that user device details in the interaction data provided to the resource provider computer 125 correspond to the same user device that was provided to the access device 120. The indication that the resource will be provided to the user can include a message displayed on a display (e.g., output device 120(e) of access device 120 indicating that the user is verified or authenticated. The access device 120 may also indicate that the resources previously purchased can be provided to the user, or the person operating the access device 120 may do this. The indication can include order details (e.g., item numbers of goods to be provided to the user, details relating to services to be rendered for the user) and other details for a resource provider to provide the resources to the user. In some embodiments, the indication may be a simple message such as “card validated.”

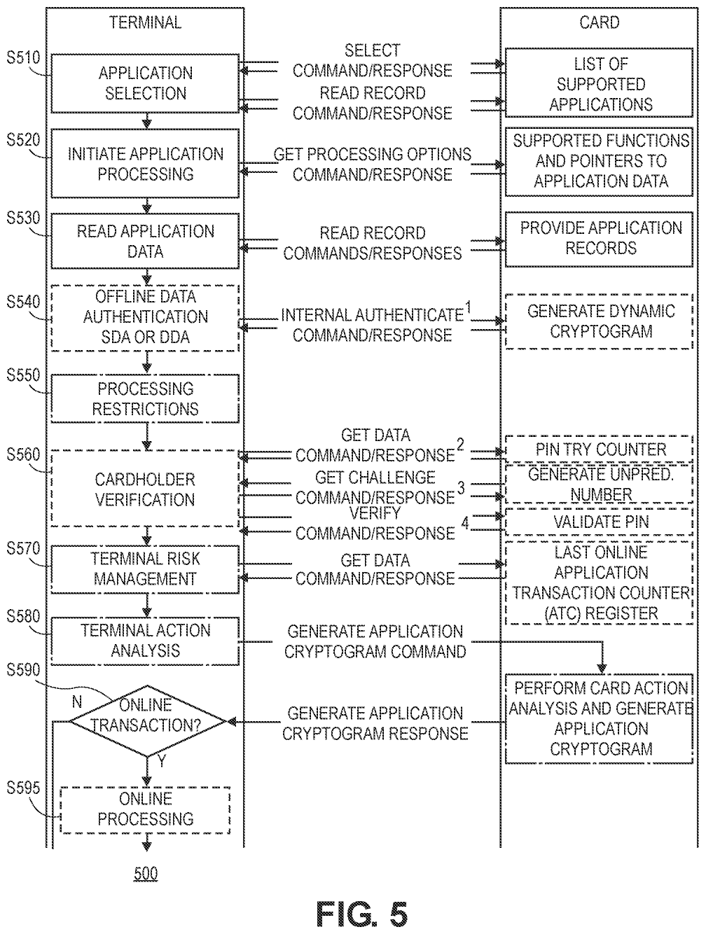

Embodiments of the present application can involve a number of communications between the user device 115 and the access device 120. For example, several messages can be exchanged during step S415 in method 400 in order to process the transaction and obtain information from the user device 115. An example flow 500 of these communications is shown in FIG. 5.

When a user device 115 contacts an access device 120, the user device 115 and access device 120 are then able to communicate. Several processing steps may take place in order to identify and prepare data for transmission to the access device 120 for the transaction. In some embodiments, Application Protocol Data Unit (APDU) messages can be exchanged between the user device 115 and the access device 120. The messages can be in the form of APDU commands sent from the access device 120 to the user device 115, and APDU responses sent from the user device 115 to the access device 120.

At step S510, the access device 120 may perform application selection. For example, the access device 120 may determine which applications are supported by both the user device 115 and the access device 120. In some embodiments, when the access device 120 detects the presence of the user device 115, the access device 120 may send an available applications request to the user device 115 to request information on which payment applications (e.g., a list of AIDs) may be available at the user device 115. In some embodiments, the available applications request may be in the form of a select command.

The user device 115 may respond by sending an available applications response back to access device 120. The available applications response may include a list of available AIDs. In some embodiments, the available applications response may be in the form of a select response.

The access device 120 may then select a suitable application from the list of applications received in the available applications response (e.g., by selecting an AID from the available AIDs). For example, the access device 120 may select a payment application (e.g., the highest priority application) that is supported by both the access device 120 and the user device 115. In some embodiments, the access device 120 may display the mutually supported applications and allow the user 110 to select an application to be used for the transaction.

The access device 120 may also send an application selection message with the selected AID to the user device 115. In some embodiments, the application selection can be in the form of a read record command or a select AID (or ADF) command.

The user device 115 may then send a request for transaction data to the access device 120 which may be needed to execute the transaction using the selected application/AID. In some embodiments, the request may be in the form of a read record response or a select AID (or ADF) response. The request may include a list of transaction data identifiers, and the list can be in the form of a processing options data object list (PDOL). The transaction data requested may include terminal transaction qualifiers (TTQ), authorized amount, other amount, terminal country code, terminal verification results, transaction currency code, transaction data, transaction type, and/or an unpredictable number.

At step S520, the access device 120 may initiate application processing. For example, the access device 120 may request that the user device 115 indicate the data (e.g., a list of files containing the data) to be used for the selected application and the functions supported. In some embodiments, the access device 120 may send a get processing options (GPO) command. The access device 120 may also provide transaction information to the user device 115 (e.g., via the GPO command). For example, the access device 120 may provide the transaction data requested by the user device 115 via a processing options data object list (PDOL). The transaction data provided may include a transaction amount, such as a final transaction amount or an estimated transaction amount (e.g., if the final transaction amount is not yet known).

The user device 115 may then generate dynamic transaction processing information using at least some of the received terminal transaction data, and send a set of transaction processing information to the access device 120. In some embodiments, the transaction processing information can be sent in the form of a GPO response. In some embodiments, the transaction processing information may include one or more application file locators (AFLs) that can be used as file addresses by access device 120 to read account data stored on user device 115.

At step S530, the access device 120 may read application data. For example, the access device 120 may send an account data request to the user device 115 to read account data stored at the user device 115. In some embodiments, the account data request may be in the form of a read record command, and may include an application file locator (AFL) indicating the location of the account data.

The user device 115 may then send the account data to the access device 120. In some embodiments, the account data may be sent in the form of a read record response. The account data may include, for example, track-2 equivalent data (e.g., payment credentials) and the cardholder name, and/or other account related data that is accessible at the AFL location. Such information (e.g., the cardholder name) in the account data may an example of the supplemental information described above.

At step S540, the access device 120 may determine whether it should authenticate the user device 115 offline. The determination can be made based on whether the user device 115 supports offline authentication. In some embodiments, one or more types of offline authentication can take place, such as Static Data Authentication (SDA) or Dynamic Data Authentication (DDA).

At step S550, the access device 120 may check for processing restrictions. For example, the access device 120 may determine whether the transaction should be allowed to continue based on a user device expiration date, a user device effective date, matching of applications between the user device 115 and access device 120, usage restrictions (e.g., restriction of international purchases or cashback services), and any other suitable restrictions.

At step S560, the access device 120 may perform cardholder verification. For example, the user 110 may be verified as the rightful user of the user device 115 and not a fraudster. One or more card verification methods (CVMs) can be used. For example, the user 110 may be prompted to provide a PIN (e.g., verified online with the authorizing entity or offline with the user device 115), signature, or any other suitable method of authentication.

At step S570, the access device 120 may perform terminal risk management. For example, the access device 120 may perform velocity checking, determine whether the transaction exceeds a merchant floor limit, check if the account number is flagged for denial, determine whether a limit of consecutive transactions has been exceeded, and/or check for any other suitable fraud indicators.

At step S580, the access device 120 may perform a terminal action analysis. For example, the access device may determine whether the transaction should be approved offline, sent online for authorization, or declined offline. As mentioned above, in some embodiments, all transactions may be authorized online. Accordingly, the access device 120 may automatically proceed to an online authorization process.

The access device 120 may then request a cryptogram from the user device 115 (e.g., via a generate application cryptogram command). The access device 120 may specifically request an authorization request cryptogram (ARQC), a transaction certificate (TC), or an application authentication cryptogram (AAC). In some embodiments, an ARQC may be requested for online authorization, a TC may be requested for offline authorization (e.g., already approved offline), and an AAC may be requested for a transaction decline or an authorization deferral. Such cryptograms are examples of the previously described cryptograms.

The user device 115 may then determine what type of cryptogram to provide to the access device. For example, the user device 115 may provide an ARQC to proceed with online authorization. Alternatively, the user device 115 may determine that the transaction should be declined, and may return an AAC.

In some embodiments, an ARQC can be generated based on transaction-specific information. For example, a transaction amount received from the access device 120 (e.g., in step S520), a transaction ID, a merchant identifier, and any other suitable transaction-linked information can be used as inputs to an ARQC-generating algorithm. Any other suitable information can also be used as input, such as a random number, a transaction counter, etc. The ARQC may be generated using an authorizing entity key that is stored in the user device 115 and known at the authorizing entity computer 140. Accordingly, the authorizing entity computer 140 can authenticate the ARQC when it is received with an authorization request message.

In some embodiments, in step S590, the access device 120 may receive the cryptogram from the user device 115 and determine whether to authorize the transaction online. For example, the access device 120 may determine whether the cryptogram is an ARQC. In some embodiments, if an ARQC is received, the access device 120 may continue with an online authorization process.

Once the cryptogram is received by the access device 120 from the user device 115, the access device 120 may determine that the cryptogram is valid as described above, and may also compare any received interaction data from a resource provider computer (not shown) to the supplemental data (e.g., the cardholder name) received from the user device 115.

In step S595, the access device 120 may store the user device 115 information (e.g., account credentials, cryptogram, etc.) for later processing. For example, the final transaction amount may not yet be known, so the access device 120 may retain the user device 115 information until authorization can be completed.

Once the necessary user device 115 information (e.g., account credentials, cryptogram, etc.) is received and stored, the user device 115 may no longer be needed at the access device 120. Accordingly, the communications between the access device 120 and user device 115 can be completed and the user device 115 removed at an earlier time. For example, the user device 115 can be removed before an authorization response message is sent, and before an authorization response message is received.

Embodiments of the invention have a number of advantages. For example, as explained above, a user need not retrieve a form of ID such as a driver's license, credit card, or the like and show the resource provider (or employee of the resource provider) the ID to obtain the desired research. The user may instead take a user device and interact with an access device at the resource provider terminal. The resource provider does not need to take physical possession of the user's ID and read it. Using embodiments of the invention, the user can use a user device to conduct a rapid and contactless authentication using a user device that is the same or substantially similar to the user device that was used to previously interact with a resource provider computer. This is particular useful in a time when social distancing and contact minimization is useful to prevent the spread of pathogens.

Further, instead of reading the user's ID, the employee of the resource provider need only rely on a successful match indication provided by an access device, in order to conclude that the user seeking access to the desired resource is in fact the user that is entitled to do so.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a,” “an,” or “the,” is intended to mean “at least one,” unless specifically indicated to the contrary.

What is claimed is:

1. A method comprising:
receiving, by an access device, interaction data from a resource provider computer operated by a resource provider, the interaction data produced during an interaction between a user and the resource provider computer in which the user attempts to obtain a resource from the resource provider using a user device;
receiving, by the access device, user device data comprising a cryptogram and supplemental data from the user device or another user device operated by the user;
obtaining, by the access device, validation of the cryptogram;
after obtaining the validation of the cryptogram, comparing, by the access device, the interaction data and the supplemental data;
determining, by the access device, the user interacting with the access device is the same user as the user that interacted with the resource provider computer; and
providing, by the access device, an indication that the user is the resource will be provided to the user.

2. The method of claim 1, wherein the receiving, by the access device, the user device data comprises receiving, by the access device, the user device data comprising the cryptogram and the supplemental data from the another user device operated by the user.

3. The method of claim 1, wherein the access device comprises an SDK, which performs at least the comparing step.

4. The method of claim 1, wherein obtaining validation of the cryptogram comprises:
generating, by the access device, an authorization request message comprising the user device data comprising the cryptogram and the supplemental data;
transmitting, by the access device, the authorization request message to a processing network computer or an authorizing entity computer; and
receiving, by the access device, an authorization response message comprising a cryptogram validation result from the processing network computer or the authorizing entity computer.

5. The method of claim 4, wherein the authorization request message comprises a null value in an amount data field.

6. The method of claim 1, further comprising:
determining, by the access device, a score indicative of a similarity between the interaction data and the supplemental data; and
determining, by the access device, that the score exceeds a threshold and that the user is the same user as the user that interacted with the resource provider computer.

7. The method of claim 1, wherein the interaction data comprises a name of the user and the supplemental data comprises the name of the user.

8. The method of claim 1, wherein the resource provider computer operates a Web site and the interaction data was obtained by the resource provider computer from the user via the Web site.

9. An access device comprising:
a processor; and
a non-transitory computer readable medium having instructions stored thereon that, when executed the processor, cause the access device to:
receive interaction data from a resource provider computer operated by a resource provider, the interaction data produced during an interaction between a user and the resource provider computer using a user device;
receive user device data comprising a cryptogram and supplemental data from the user device or another user device operated by the user;
obtain validation of the cryptogram;
after obtaining validation of the cryptogram, compare the interaction data and the supplemental data to derive a similarity between the interaction data and the supplemental data included in the user device data;
determine the user interacting with the access device is the same user as the user that interacted with the resource provider computer responsive to identifying the similarity between the interaction data and the supplemental data included in the user device data exceeding a threshold; and
provide an indication that a resource will be provided to the user.

10. The access device of claim 9, wherein the non-transitory computer readable medium further has instructions stored thereon that, when executed, further causes the computer to obtain validation of the cryptogram by:
transmitting the cryptogram to an authorizing entity computer; and
obtain validation of the cryptogram from the authorizing entity computer.

11. The access device of claim 9, wherein the access device is in the form of a mobile phone.

12. The access device of claim 9, wherein the access device further comprises:
an application programming interface (API) connecting the access device to the resource provider computer, wherein the interaction data is received from the resource provider computer via the API.

13. The access device of claim 9, wherein the access device is a mobile phone, the access device further comprising:
a wireless network interface configured to obtain the user device data from the user device by obtaining short-range wireless communication message data.

14. The access device of claim 9, wherein the supplemental data comprises a name of the user and the interaction data comprises the name of the user.

15. The access of claim 14, wherein the name of the user in the supplemental data is different than but is substantially similar to the name in the interaction data.

16. The access device of claim 9, further comprising a contactless reader coupled to the processor, the contactless reader capable of reading data from the user device.

17. A computer-implemented method comprising:
providing, by a communication device, to a resource provider computer, interaction data; and
providing, by a user device to an access device at a location of the resource provider, user device data comprising a cryptogram and supplemental data, wherein the access device receives the interaction data from the resource provider computer, obtains validation of the cryptogram, and compares the interaction data and the supplemental data, determines that the user interacting with the access device is the same user as the user that interacted with the resource provider computer, and provides an indication that a resource will be provided to the user.

18. The computer-implemented method of claim 17, wherein the communication device is a laptop computer.

19. The computer-implemented method of claim 17, wherein the user device is a card.

20. The computer-implemented method of claim 17, wherein the resource is a secure location in the form of a building.
